(19) United States
(12) Patent Application Publication
(10) Pub. No.: US 2008/0276920 A1
(43) Pub. Date: Nov. 13, 2008

(54) Exhaust emission control device of an internal combustion engine

(76) Inventors: Kinichi Iwachido, Aichi-gun (JP); Hiroaki Ohhara, Anjo-shi (JP); Tetsuya Watanabe, Okazaki-shi (JP)

Correspondence Address: BIRCH STEWART KOLASCH & BIRCH, PO BOX 747, FALLS CHURCH, VA, 22040-0747, US

(21) Appl. No.: 11/907,915

(22) Filed: Oct. 18, 2007

(30) Foreign Application Priority Data
Oct. 30, 2006 (JP) 2006-294075

(51) Int. Cl. F02D 41/00

(52) U.S. Cl. 123/703; 701/103; 701/109

(57) ABSTRACT

As forcible modulation parameters, a cycle and an amplitude are set so that O₂ and CO concentrations in emissions at a catalyst inlet can be increased, and based upon the preset parameters, forcible modulation that forcibly fluctuates an exhaust air-fuel ratio is carried out to facilitate catalysis for early activation, and the forcible modulation is then switched to O₂-F/B control.

### BACKGROUND OF THE INVENTION

1. Field of the Invention

The present invention relates to an exhaust control device of an internal combustion engine, and more specifically to an exhaust control device that facilitates catalysis immediately after engine start and improves emission control performance by early activation of a catalyst.

2. Description of the Related Art

Hazardous components, which are exhausted from the engine at cold start where a catalyst is not yet activated, including, for example, THC (total HC) and the like make up a considerable percentage of the total amount of THC emissions produced through every mode operation of the engine. As is known, it is therefore important to take measures at cold start for improvement of emission control performance. One of the measures to that end is a method in which, immediately after engine start, an exhaust air-fuel ratio is first set at a substantially steady value on the rich side by open-loop (hereinafter abbreviated to O/L) control characterized in that the concentration of engine-out exhaust gases (especially HC) is low, and that combustion fluctuation is allowed. When an O₂ sensor is later activated, the open-loop control is switched to feedback control for attaining a theoretical air fuel ratio based upon the output from the O₂ sensor (hereinafter, referred to as O₂-F/B control).

However, this method has a drawback that the emission control performance is greatly affected by a support amount of precious metal of a three-way catalyst. This drawback is noticeable especially in the process where the O/L control is switched to the O₂-F/B control. As the support amount of precious metal is reduced, the emission control performance is drastically deteriorated. This conventional method cannot provide satisfactory emission control performance if the support amount of precious metal comes short. On the contrary, if the support amount of precious metal is increased to ensure satisfactory emission control performance, this raises other problems including an increase in cost, a pressure drop increase caused by the increase of catalyst capacity, etc.

At the same time, a technology has been suggested, which implements the forcible modulation of the air-fuel ratio for the purpose of suppressing the emission of hazardous components immediately after engine start (for example, see Japanese Patent No. 3392197). The forcible modulation is control that forcibly fluctuates the exhaust air-fuel ratio of the engine alternately between rich and lean directions with the given amplitude. According to the technology disclosed in the above publication, the forcible modulation is carried out at cold start, and a reducing reaction is made to occur on the catalyst during the modulation in the rich direction. Simultaneously, an oxidative reaction is made to occur on the catalyst during the modulation in the lean direction. This promotes the catalyst temperature rise and improves the emission control performance.

According to the technology disclosed in the publication, the forcible modulation is switched to the regular O₂-F/B control after the O₂ sensor is activated. However, considering that the fluctuation of the air-fuel ratio continues for a while after switchover, which hinders a rapid convergence of the exhaust air-fuel ratio to the theoretical air-fuel ratio (namely, within a catalyst window), the amplitude of the exhaust air-fuel ratio during the forcible modulation is reduced in proportion to increases in the engine water temperature correlated with the activation state of the catalyst. This enhances the convergence to the theoretical air-fuel ratio at the switching to the O₂-F/B control.

In the technology disclosed in the publication, however, the amplitude of the exhaust air-fuel ratio is set, placing the top priority on switchability from the forcible modulation to the O₂-F/B control. For this reason, it is hard to say that the setting is proper for acceleration of catalyst temperature rise, that is, improvement of the emission control performance which is achieved by early activation.

In other words, the reducing and oxidative reactions occurring on the catalyst, which are caused by forcible modulation, closely relate to the amount of CO and O₂ supplied onto the catalyst with exhaust gases. Therefore, unless the supply amount is properly controlled, it is unlikely to realize proper reducing and oxidative reactions, that is, sufficient acceleration of temperature rise. The technology disclosed in the publication merely controls the amplitude of the exhaust air-fuel ratio on the premise of the switchover to the O₂-F/B control. It is therefore impossible to supply a sufficient amount of CO and O₂ onto the catalyst during the forcible modulation. This causes the problem that the emission control performance cannot be improved by accelerating the catalyst temperature rise.

### SUMMARY OF THE INVENTION

The present invention has been made to solve the above problems. It is an object of the invention to provide an exhaust emission control device of an internal combustion engine capable of implementing forcible modulation before starting O₂-F/B control after engine startup, properly controlling a fluctuation condition of an exhaust air-fuel ratio at this time point and supplying sufficient amounts of CO and O₂ onto a catalyst, and achieving early activation by acceleration of catalyst temperature rise and improving emission control performance regardless of a support amount of precious metal of the catalyst.

To accomplish the above object, the invention has a catalyst placed in an exhaust path of an internal combustion engine; air-fuel ratio detection means disposed in the exhaust path so as to be located upstream from the catalyst; feedback control means that carries out feedback control so as to approximate an actual air-fuel ratio of the internal combustion engine to a target air-fuel ratio according to output of the air-fuel ratio detection means; and means for controlling air-fuel ratio fluctuation, which operates before the feedback control means is operated after the startup of the internal combustion engine and forcibly fluctuates an air-fuel ratio of emissions flowing to the catalyst between a lean air-fuel ratio and a rich air-fuel ratio. The means for controlling air-fuel ratio fluctuation operates on the basis of a cycle and an amplitude that are so determined that both O₂ and CO concentrations in emissions at an inlet of the catalyst are higher than during operation of the feedback control means.

By so doing, the exhaust air-fuel ratio is forcibly fluctuated before the feedback control to be carried out after engine startup is commenced. At the same time, the fluctuation amplitude and cycle of the exhaust air-fuel ratio at this time point are set so that both the O₂ and CO concentrations in emissions are higher than during the feedback control. As a result, it is possible to supply sufficient amounts of CO and O₂ onto the catalyst, achieve early activation by acceleration of catalyst temperature rise, and improve emission control performance without increasing the support amount of precious metal of the catalyst.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 is a view showing the entire configuration of an engine and an exhaust emission control device thereof according to an embodiment of the invention;

FIG. 2 is a characteristic diagram showing changes of CO and O₂ concentrations, which are caused by difference of an amplitude of an exhaust air-fuel ratio during forcible modulation;

FIG. 3 is a flowchart showing a startup emission control routine that is implemented by an ECU;

FIG. 4 is a time chart showing a waveform pattern of the exhaust air-fuel ratio during forcible modulation in a first embodiment;

FIG. 5 is a flowchart showing a routine of calculating forcible modulation parameters, which is implemented by the ECU of the first embodiment;

FIG. 6 is a time chart showing a switching condition of emission control and changes of required O₂ and CO concentrations in relation to catalyst temperature at cold start of an engine;

FIG. 7 is a characteristic diagram in which concentrations of engine-out exhaust gases obtained by forcible modulation is compared to exhaust gas concentrations obtained by O/L control and O₂-F/B control;

FIG. 8 is a characteristic diagram in which the O/L control and the O₂-F/B control are compared to each other in terms of a purification efficiency of NMHC during forcible modulation;

FIG. 9 is a characteristic diagram in which the O/L control and the O₂-F/B control are compared to each other in terms of a purification efficiency of CO during forcible modulation;

FIG. 10 is a characteristic diagram in which the O/L control and the O₂-F/B control are compared to each other in terms of a purification efficiency of NOx during forcible modulation;

FIG. 11 is a flowchart showing a routine of calculating forcible modulation parameters, which is implemented by an ECU of a second embodiment; and

FIG. 12 is a time chart showing a waveform pattern of the exhaust air-fuel ratio during forcible modulation in the second embodiment.

### DETAILED DESCRIPTION OF THE PREFERRED EMBODIMENTS

### First Embodiment

A first embodiment of an exhaust emission control device of an engine, which embodies the present invention, will be described below.

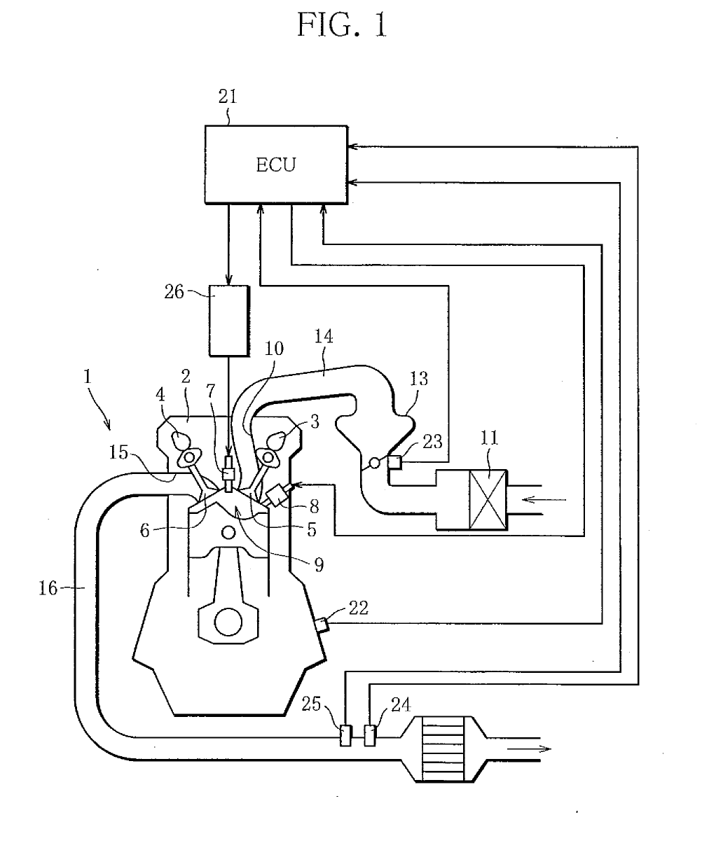

FIG. 1 is a view of an entire constitution schematically showing an engine and an exhaust emission control device according to the first embodiment, and relates to an in-line four-cylinder gasoline engine of an in-cylinder injection type 1. A valve driving mechanism of a DOHC four-valve type is employed as the engine 1. An intake cam shaft 3 and an exhaust cam shaft 4 mounted on a cylinder head 2 are rotated by a crank shaft, not shown. An intake valve 5 and an exhaust valve 6 are opened/closed by the cam shafts 3 and 4 with given timing.

In each cylinder, an electromagnetic fuel injection valve 8 is fixed to the cylinder head 2 together with an ignition plug 7. High-pressure fuel that is supplied from a fuel pump, not shown, is directly injected into a combustion chamber 9 according to the opening/closing of the fuel injection valve 8. An intake port 10 is formed in the cylinder head 2 so as to extend in a substantially upright direction between the cam shafts 3 and 4. Upon the opening of an intake valve 5, intake air is guided into the combustion chamber 9 through an air cleaner 11, a throttle valve 12, a surge tank 13, an intake manifold 14, and an intake port 10. The exhaust gases after combustion are discharged from the combustion chamber 9 to an exhaust port 15 along with the opening of the exhaust valve 6, and is discharged into atmosphere through an exhaust path 16 and a three-way catalyst 17.

In a vehicle interior, there are installed an input/output device, not shown, storage devices (ROM, RAM, etc.) for storing a control program, a control map, etc., a central processing unit (CPU), and an ECU (engine control unit) 21 with a timer and the like, which carry out comprehensive control of the engine 1. An input side of the ECU 21 is connected with various kinds of sensors including a water temperature sensor 22 for detecting coolant temperature T_{w} of the engine 1, a throttle sensor 23 for detecting throttle opening θₜₕ, a temperature sensor 24 for detecting exhaust gas temperature (hereinafter, referred to as inlet temperature) Tₑₓ flowing into the three-way catalyst 17, an O₂ sensor 25 (air-fuel ratio detection means) for changing output according to O₂ concentration in the exhaust gases, etc. An output side of the ECU 21 is connected with various kinds of devices including the fuel injection valve 8, an igniter 26 for driving the ignition plug 7, etc.

The ECU 21 determines ignition timing, fuel injection amount, and the like, on the basis of detection information from the sensors, and controls the operation of the engine 1 by driving the igniter 26 and the fuel injection valve 8 on the basis of the control amounts.

At cold start of the engine 1, the ECU 21 implements O₂-F/B control for a target air-fuel ratio (for example, theoretical air-fuel ratio) on the basis of output of the O₂ sensor 25 (feedback control means), and carries out forcible modulation by O/L control prior to the O₂-F/B control (means for controlling air-fuel ratio fluctuation). When implementing the forcible modulation, on the basis of target values of CO and O₂ concentrations (required CO and O₂ concentrations described below) which are obtained from catalyst temperature T_{cat} and the like, the ECU 21 sets control amounts of amplitude, cycle and the like of the forcible modulation for attaining these target values, and controls supply amounts of CO and O₂ supplied to the three-way catalyst 17 through the forcible modulation based upon the control amounts. Emission control at the cold start will be described below.

Prior to an explanation of the control of the ECU 21, characteristics of the CO and O₂ concentrations in the exhaust gases according to an execution state of the forcible modulation will be first described.

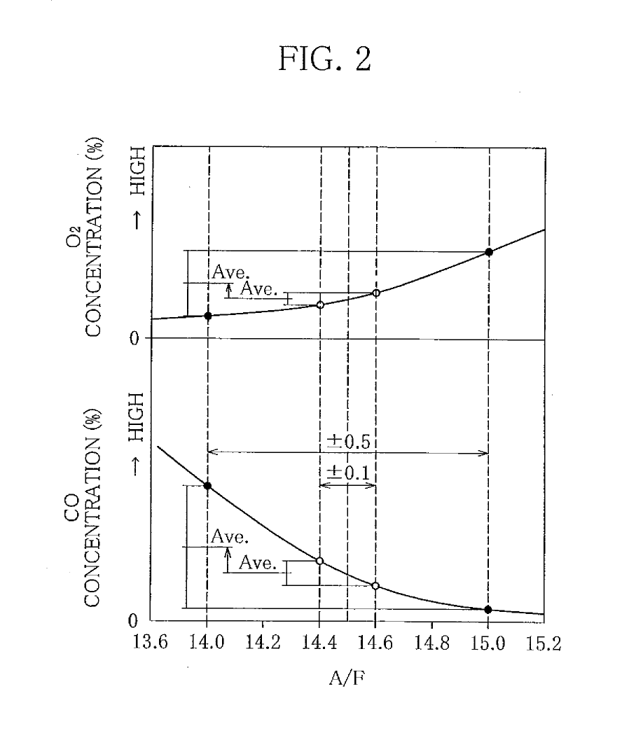

FIG. 2 is a characteristic view showing changes of the CO and O₂ concentrations due to a difference in amplitude of an exhaust air-fuel ratio during the forcible modulation. The CO and O₂ concentrations in the exhaust gases are increased or decreased along characteristic lines in FIG. 2 along with the changes of the exhaust air-fuel ratio. More specifically, the CO concentration is gradually decreased as the exhaust air-fuel ratio becomes high, while the O₂ concentration is gradually increased as the exhaust air-fuel ratio becomes high. During the forcible modulation, the CO and O₂ concentrations are repeatedly increased and decreased within a zone corresponding to the amplitude of the exhaust air-fuel ratio on the respective characteristic lines with respect to each cycle of a waveform pattern, and average CO and O₂ concentrations per cycle are increased or decreased together according to the amplitude of the exhaust air-fuel ratio. In FIG. 2, on the premise that a center air-fuel ratio is 14.5, a comparison is made between the case where the amplitude is 0.1 and the case where the amplitude is ±0.5. As compared to the amplitude of ±0.1, if the amplitude is increased up to ±0.5, the average CO and O₂ concentrations per cycle (referred to as “Ave.” in FIG. 2) are increased together.

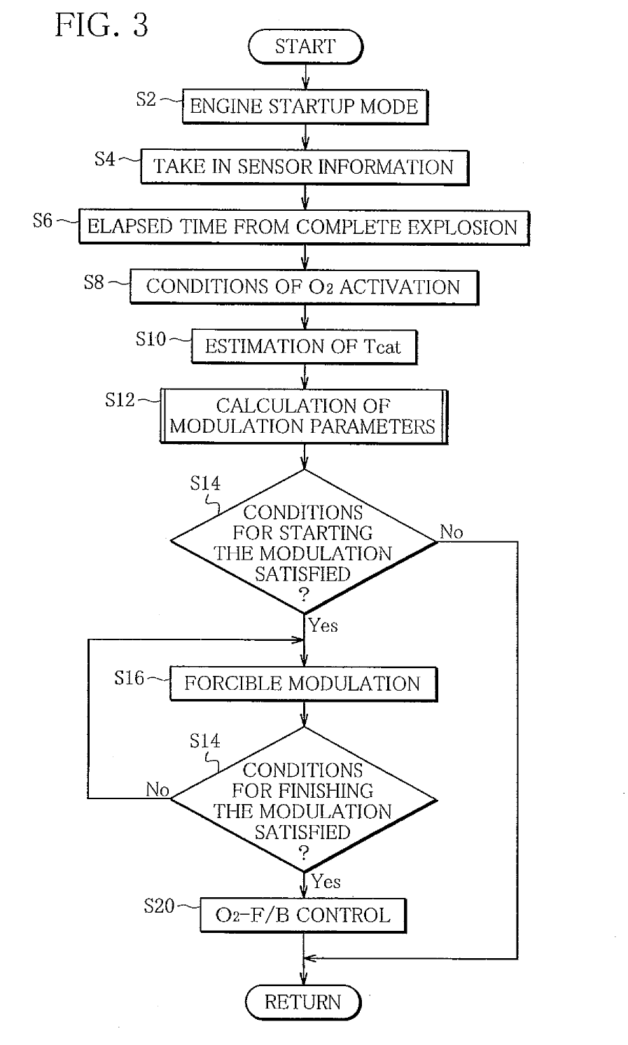

FIG. 3 is a flowchart showing a startup emission control routine that is implemented by the ECU 21. The ECU 21 carries out the routine at engine start at given control intervals.

First, an engine startup mode is carried out in Step S2.

In the startup mode, startup increase-amount compensation for the startup time from the start of cranking to a complete explosion judgment, post-startup increase-amount compensation and the like are properly carried out by the O/L control, which ensures smooth engine start. Contents of the engine startup mode are commonly known. Fuel control that is carried out by the post-startup increase-amount compensation at this point corresponds to the O/L control based upon the rich air-fuel ratio which is implemented before the O₂ sensor is activated as described under “Description of the Related Art.”

Step S4 then takes in sensor information including the coolant temperature T_{w}, the throttle opening θₜₕ, the inlet temperature Tₑₓ, etc. In the subsequent Step S6, elapsed time from startup completion (complete explosion judgment) is calculated. Step S8 determines conditions of activation of the O₂ sensor 25, and Step S10 estimates the catalyst temperature T_{cat} on the basis of the inlet temperature Tₑₓ. Although the catalyst temperature T_{cat} is calculated from a map in which relationship between the preset inlet temperature Tₑₓ and the preset catalyst temperature T_{cat} is defined, a method of calculating the catalyst temperature T_{cat} is not limited to the above method. For example, instead of estimating from the inlet temperature Tₑₓ, it is possible to directly detect bed temperature of the three-way catalyst 17 or to simply find the catalyst temperature T_{cat} on the basis of the coolant temperature T_{w} and the elapsed time from the startup completion.

The subsequent Step S12 calculates forcible modulation parameters. In the present embodiment, the amplitude and cycle of the exhaust air-fuel ratio during forcible modulation are calculated as forcible modulation parameters. Details will be described later.

Thereafter, Step S14 makes a determination as to whether conditions for starting the forcible modulation are satisfied. The conditions for starting the forcible modulation are set to maintain such an engine operation state that there is no problem if the forcible modulation that forcibly fluctuates the exhaust air-fuel ratio of the engine 1 is carried out. The determination is made, for example, on the basis of the following items (1) to (5).

(1) Engine load, and more specifically, the throttle opening θₜₕ, volumetric efficiency, etc.
(2) Elapsed time after the engine startup completion
(3) Coolant temperature T_{w}
(4) Elapsed time after the activation of the O₂ sensor
(5) Catalyst temperature T_{cat}

If Step S14 determines that the conditions for starting the forcible modulation are not satisfied in view of these items and makes a judgment of NO (denial), the routine is ended. In this case, the O/L control based upon a rich air-fuel ratio that is substantially steady as in conventional control is continuously carried out in the engine startup mode of Step S2.

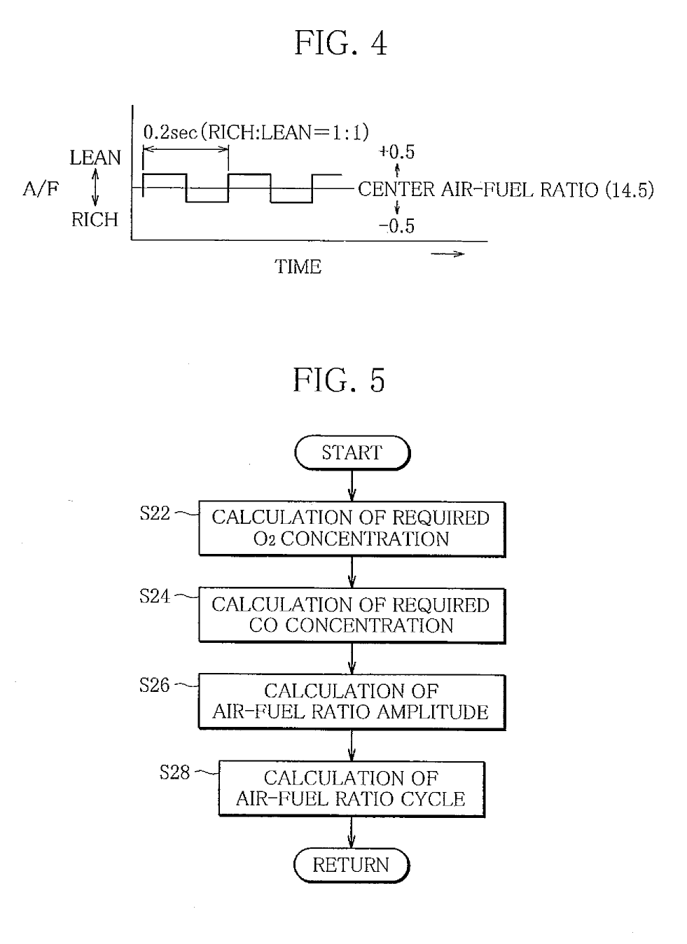

If Step S14 determines that the conditions for starting the forcible modulation are satisfied and makes a judgment of YES (affirmation), the routine moves to Step S16, which implements the forcible modulation of the exhaust air-fuel ratio. According to the present embodiment, a waveform pattern, in which fluctuation amounts of the exhaust air-fuel ratio in rich and lean directions in relation to the center air-fuel ratio are set equal to each other, and fluctuation periods in the rich and lean directions in one cycle are also set equal to each other, is applied to the forcible modulation. FIG. 4 is a time chart showing the waveform pattern of the exhaust air-fuel ratio during forcible modulation. On the premise that the center air-fuel ratio is 14.5, the amplitude and the cycle are set at 1.0 and 0.2 sec, respectively. The amplitude is set to ±0.5. Regarding the cycle, the rich and lean fluctuation periods are each set at 0.1 sec.

The Step S18 makes a determination as to whether conditions for finishing the forcible modulation are satisfied. The conditions for finishing the forcible modulation are set as such engine operation conditions that the emission control performance is not deteriorated if the routine moves to the regular O₂-F/B control after the forcible modulation is finished (in short, the three-way catalyst 17 is already activated). The determination is made, for example, on the basis of the catalyst temperature T_{cat} and the like.

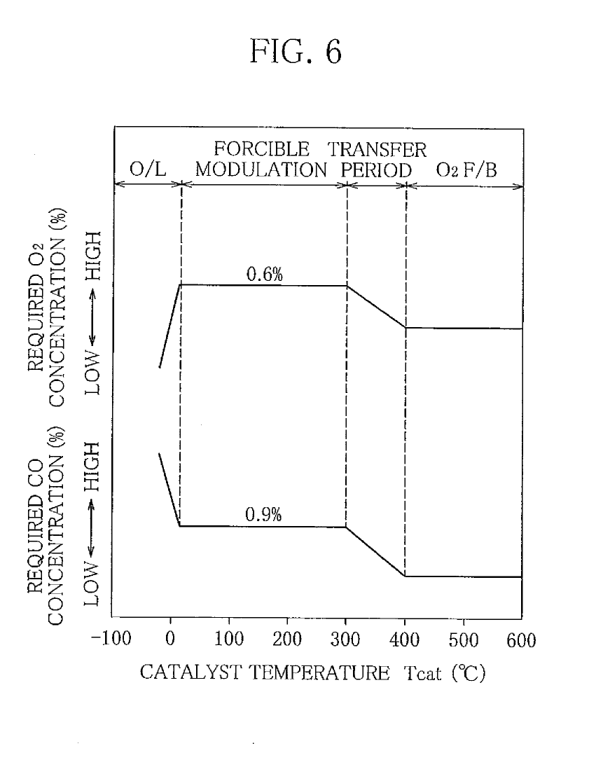

If the judgment of Step S18 is NO, the routine returns to Step S16. Therefore, the forcible modulation of Step S16 continues until the conditions for finishing the forcible modulation are satisfied. When the judgment of Step S18 is YES because of satisfaction of the conditions for finishing the forcible modulation, the forcible modulation is switched to the O₂-F/B control for the theoretical air-fuel ratio based upon the output of the O₂ sensor in Step S20. The routine is then ended. A transfer period (shown in FIG. 6) is set for the purpose of preventing a sudden change of the operation state when the forcible modulation is switched to the O₂-F/B control so that the amplitude and the cycle are gradually reduced during the transfer period to slowly transfer to the O₂-F/B control.

The ECU 21 carries out the processing of Step S12 according to a routine of calculating forcible modulation parameters, which is shown in FIG. 5. The processing performed by the ECU 21 will be described below.

First, the required O₂ concentration is calculated in Step S22, and the required CO concentration in Step S24. The calculation processing is carried out according to a map in which the required O₂ and CO concentrations are preset with respect to each value of the catalyst temperature T_{cat} on the basis of the catalyst temperature T_{cat} estimated by the processing of Step S10.

In Steps S26 and S28, a waveform pattern during forcible modulation, which provides the required O₂ and CO concentrations, is determined, and the routine is then ended. In other words, according to the present embodiment, because of the same fluctuation amounts and periods in the rich and lean directions of the exhaust air-fuel ratio during forcible modulation, the waveform pattern is determined on the basis of the amplitude and the cycle. Accordingly, Step S26 determines the amplitude of the exhaust air-fuel ratio from the required O₂ and CO concentrations, whereas Step S28 determines the cycle of the exhaust air-fuel ratio from the required O₂ and CO concentrations. The above-mentioned processing is carried out according to a map in which the amplitude and the cycle are set with respect to each of the required O₂ and CO concentrations.

In Step S26, as compared to the fluctuation of the exhaust air-fuel ratio which is caused by the O/L control and the O₂-F/B control, the amplitude of the exhaust air-fuel ratio is set at a greater value. To be more concrete, there generates an oscillation in the exhaust air-fuel ratio during the O/L control, and the exhaust air-fuel ratio is fluctuated by feedback during the O₂-F/B control. The amplitude that is set in Step S26 is greater than the oscillation and the fluctuation.

The amplitude and the cycle do not necessarily have to be changed at the same time according to the required O₂ and CO concentrations. For instance, it is possible to set only the amplitude according to the required O₂ and CO concentrations, and set the cycle at a given fixed value. To the contrary, it is also possible to set only the cycle according to the required O₂ and CO concentrations, and set the amplitude at a given fixed value.

The amplitude and the cycle may be set in consideration of not only the required O₂ and CO concentrations but also other items, including a type of the three-way catalyst 17 (the blending quantity of precious metal such as Pₜ, P_{d}, and Rₕ), oxygen storage capacity, a deterioration degree, a target component for reducing the exhaust gases in light of emission control and the like (which hazardous component should be preferentially reduced), etc. More concretely, the amplitude and the cycle may be calculated, taking into account the catalyst type and the oxygen storage capacity that have already been known, or taking into account the deterioration degree of the three-way catalyst 17 which has been estimated by a well-known deterioration judging method. The amplitude and the cycle may also be calculated according to whether HC or NOx is preferentially reduced.

Depending upon the amplitude and the cycle during forcible modulation, a combustion fluctuation creates a considerable torque fluctuation and degrades drivability. Therefore, in Steps S26 and S28, if the preset amplitude and cycle exceed acceptable values determined in consideration of the torque fluctuation, an upper limit of the amplitude and that of the cycle may be limited to the acceptable values.

FIG. 6 is a time chart showing switching conditions of the emission control and the transfer of the required O₂ and CO concentrations in relation to catalyst temperature at cold start of the engine. Through the processing of the ECU 21, the startup increase-amount compensation and the post-startup increase-amount compensation by the O/L control are carried out as the engine startup mode at the time of and immediately after engine start. The forcible modulation is subsequently commenced. In the example shown in FIG. 6, the required O₂ concentration is set at 0.6 percent, and the required CO concentration at 0.9 percent during forcible modulation. Thereafter, the forcible modulation is switched to the O₂-F/B control through the transfer period. As a result, the required O₂ and CO concentrations are lowered than during forcible modulation.

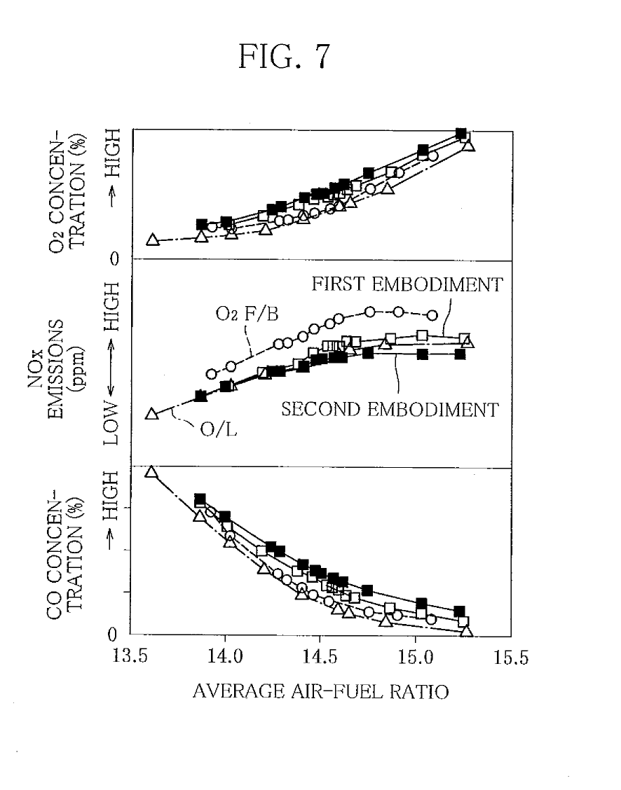

FIG. 7 is a characteristic diagram in which a concentration of engine-out (that is, catalyst inlet) exhaust gases due to the forcible modulation is compared to an exhaust gas concentration due to the O/L control and the O₂-F/B control in the engine startup mode. FIG. 7 shows data of the forcible modulation as the first embodiment, in which the amplitude and the cycle shown in FIG. 4 are set to ±0.5 and 0.1 sec in both the rich and lean directions. As illustrated in FIG. 7, albeit slight difference according to the average air-fuel ratio, both the O₂ and CO concentrations are increased during the forcible modulation, as compared to during the O/L control and the O₂-F/B control, while NOx emissions are maintained low. It is then possible to obtain a desirable exhaust-gas characteristic in connection with a catalyst temperature rise. Because of this characteristic, the required O₂ and CO concentrations shown in FIG. 6 can be achieved during forcible modulation.

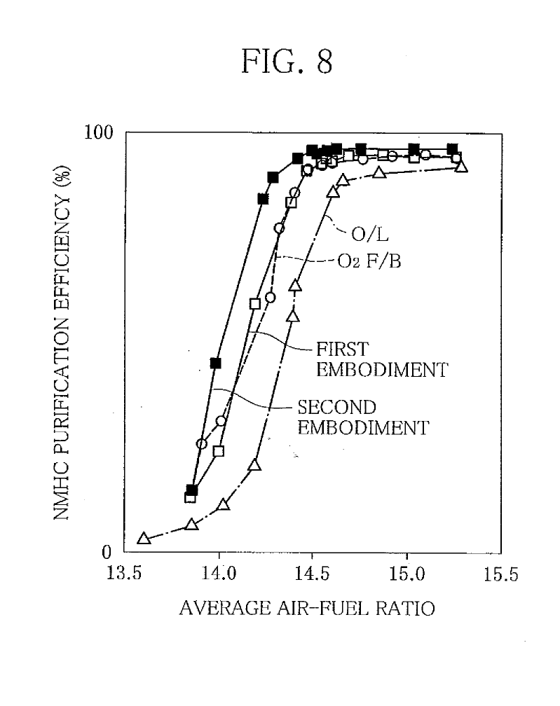

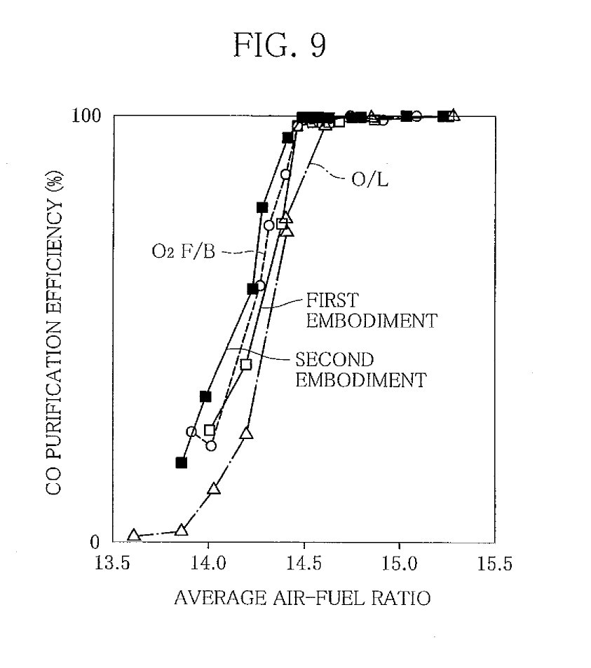

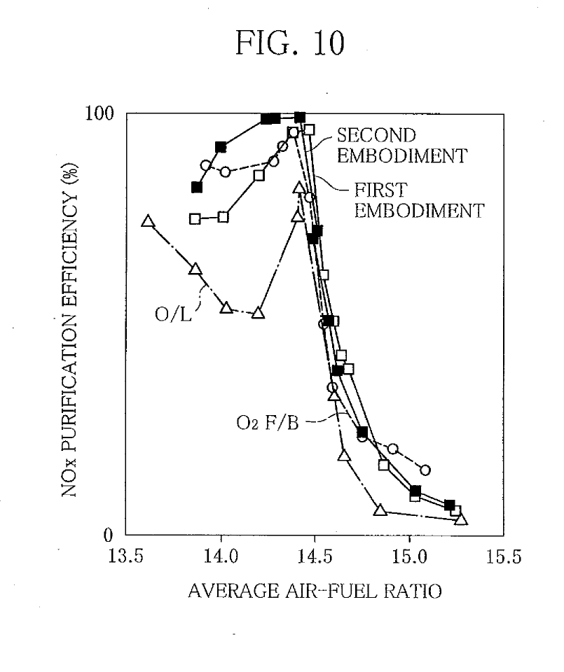

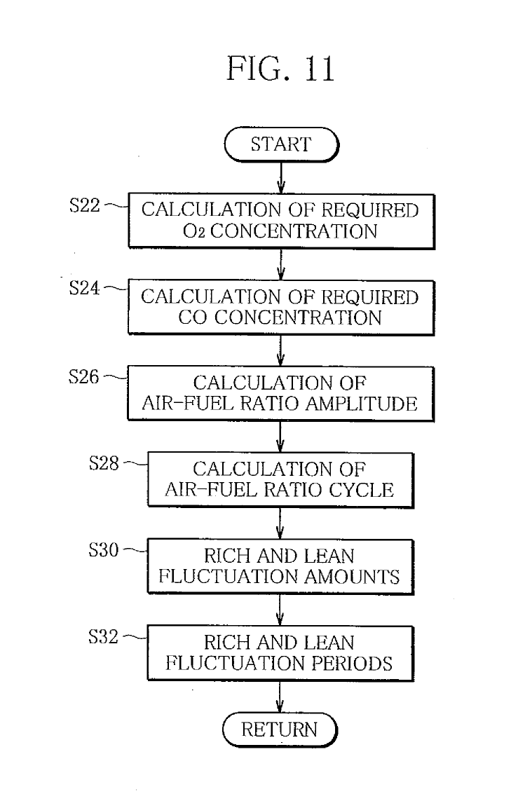

FIG. 8 is a characteristic diagram in which the O/L control and the O₂-F/B control are compared to each other in terms of purification efficiency of NMHC (Non-Methane HC) during the forcible modulation. FIG. 9 is a characteristic diagram in which the O/L control and the O₂-F/B control are compared to each other in terms of purification efficiency of CO during the forcible modulation. FIG. 10 is a characteristic diagram in which the O/L control and the O₂-F/B control are compared to each other in terms of purification efficiency of NOx during the forcible modulation. These figures show as the first embodiment the same conditions for executing the forcible modulation as those in FIG. 7. It is apparent from the above figures that the purification efficiency that is substantially equal to the purification efficiency during the O₂-F/B control, in which the three-way catalyst 17 is more activated due to a temperature rise, is achieved during forcible modulation in respect of any of NMHC, CO and NOx.

As described above, in the exhaust emission control device of the engine 1 according to the present embodiment, the forcible modulation is carried out before the O₂-F/B control after cold start of the engine 1 is started. The cycle and amplitude of the exhaust air-fuel ratio is set so that the O₂ and CO concentrations in emissions at the catalyst inlet are higher during the forcible modulation than during the O₂-F/B control. Consequently, it is possible to supply sufficient amounts of CO and O₂ onto the three-way catalyst 17, and accelerate the temperature rise of the three-way catalyst 17 and achieve early activation of the three-way catalyst 17, to thereby improve the emission control performance and reduce a support amount of precious metal of the catalyst.

It is also possible during forcible modulation to supply more sufficient amounts of CO and O₂ onto the catalyst and further accelerate the catalyst temperature rise in order to set the amplitude of the exhaust air-fuel ratio at a greater value than the fluctuation of the exhaust air-fuel ratio, which is caused by the O/L control and the O₂-F/B control.

### Second Embodiment

A second embodiment in which the present invention is embodied into another exhaust emission control device of the engine 1 will described below.

The exhaust emission control device of the present embodiment is the same as that of the first embodiment in terms of the entire constitution and basic contents of the control that is implemented by the ECU 21. There is a difference in the processing of calculating forcible modulation parameters. Therefore, descriptions about the same constitution will be omitted, and mainly the difference will be explained.

According to the present embodiment, a waveform pattern, in which fluctuation amounts of the exhaust air-fuel ratio in the rich and lean directions in relation to the center air-fuel ratio are differentiated, and fluctuation periods in the rich and lean directions in one cycle are differentiated, is applied to the forcible modulation. Therefore, as the routine of calculating forcible modulation parameters for determining the waveform pattern, a flowchart shown in FIG. 11, instead of the one in FIG. 5, is used in the present embodiment.

In FIG. 11, as in the first embodiment, the ECU 21 calculates the required O₂ and CO concentrations in Steps S22 and S24, and determines the amplitude and cycle of the exhaust air-fuel ratio from the required O₂ and CO concentrations in Steps S26 and S28. The routine then advances to Step S30, which determines the amounts of fluctuations from the center air-fuel ratio in the rich and lean directions. In Step S32, the fluctuation periods in the rich and lean directions are determined. Accordingly, when the routine moves from Step S14 to Step S16 in FIG. 3 due to the satisfaction of the conditions for starting the forcible modulation, in addition to the amplitude and the cycle of the first embodiment, a waveform pattern during forcible modulation is determined on the basis of the fluctuation amounts and periods in the rich and lean directions.

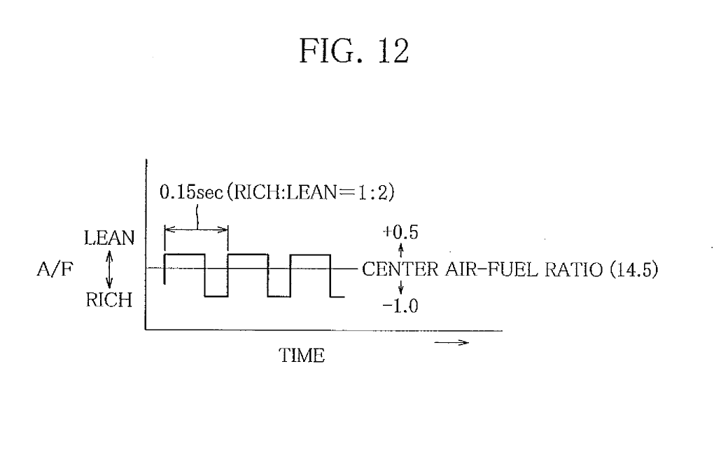

In Step S30, the fluctuation amount in the rich direction is set at a greater value than that in the lean direction. In Step S32, the fluctuation period in the rich direction is set at a smaller value than that in the lean direction. The forcible modulation by the processing of Step S16 is then carried out, for example, according to a time chart shown in FIG. 12. In this example, on the premise of a center air-fuel ratio of 14.5, the amplitude is set at 1.5, and the cycle at 0.15 sec. The amplitude is set +0.5 (lean side) and −1.0 (rich side) so that the fluctuation amount in the rich direction is greater than that in the lean direction. The cycle is set at 0.05 sec in the rich period and 0.1 sec in the lean period so that the fluctuation period in the rich direction is shorter than that in the lean direction. In this example of the setting, an average air-fuel ratio equal to that in the first embodiment shown in FIG. 4 is attained.

As described above, in the exhaust emission control device of an internal combustion engine according to the present embodiment, in addition to the setting during the forcible modulation of the first embodiment, the amplitude of the exhaust air-fuel ratio is set so that the fluctuation amount in the rich direction is greater than that in the lean direction, and the cycle of the exhaust air-fuel ratio is set so that the fluctuation period in the rich direction is shorter than that in the lean direction. Based upon the above setting, the forcible modulation is carried out.

In order to purge the O₂ absorbed by a precious metal site during the lean period and enhance the activation of the precious metal, it is preferable that reduced gases (CO, H₂, and HC) in a higher concentration than O₂ concentration be supplied. To that end, it is required to increase the concentration of the CO supplied to the catalyst inlet. The lean state is allowed to continue in some measure due to the oxygen storage capacity of the catalyst. However, if CO and HC in a high concentration flow into the three-way catalyst 17, and a reduction atmosphere continues to exceed the oxygen storage capacity of the three-way catalyst 17, the activation of the precious metal of the catalyst 17 is deteriorated. To avoid this problem, it is required to prevent the reduction atmosphere to continue for an excessively long period of time.

According to the present embodiment, during the forcible modulation, the exhaust air-fuel ratio is fluctuated more widely in the rich direction than in the lean direction, and the fluctuation in the rich direction is set shorter than that in the lean direction. Consequently, in addition to the operation and advantages of the first embodiment, it is possible to further increase the concentration of the CO supplied to the catalyst inlet, improve the emission control performance by further accelerating the catalyst temperature rise, and achieve an efficient catalyst temperature rise by suppressing the deterioration of the activation of the precious metal of the three-way catalyst 17 which is caused by the continuation of the reduction atmosphere.

Furthermore, although absorption and separation characteristics with respect to precious metal are different depending upon the types of gases, since the lean and rich air-fuel ratios are controlled in millisecond order to enhance the activation of the precious metal, it is possible to optimize gas atmosphere balance of a precious metal surface. This factor also contributes to the above-described operation and advantages.

FIGS. 7 to 10 show the conditions for implementing the forcible modulation of the present embodiment as the second embodiment. FIG. 7 shows that the O₂ and CO concentrations are more increased, and the NOx emissions are more suppressed in the forcible modulation of the present embodiment, as compared to that of the first embodiment. FIGS. 8 to 10 show that the purification efficiency of the NMHC, CO, and NOx is enhanced further than in the first embodiment. These experimental results also exemplify the operation and advantages of the present embodiment.

Although the descriptions of the embodiments will be finished here, aspects of the present invention are not limited to the above-mentioned embodiments. For example, the first embodiment implements the forcible modulation according to the time chart of FIG. 4, and the second embodiment according to the time chart of FIG. 12. Needless to say, the amplitude and the cycle during the forcible modulation are not limited to those in the first and second embodiments, and may be modified without deviating from the gist of the invention.

Although in the embodiments, the exhaust path 16 of the engine 1 is provided with the three-way catalyst 17 only, it is also possible to arbitrarily add a proximate catalyst, a NOx catalyst or the like.

The invention is applicable not only to a direct-injection engine but also to an intake-manifold-injection engine. Moreover, it is possible to control a target value of the air-fuel ratio by placing an O₂ sensor in the downstream from the catalyst.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims. The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An exhaust emission control device of an internal combustion engine, comprising:
a catalyst placed in an exhaust path of an internal combustion engine;
air-fuel ratio detection means placed in the exhaust path so as to be located upstream from the catalyst;
feedback control means for carrying out feedback control so as to approximate an actual air-fuel ratio of the internal combustion engine to a target air-fuel ratio according to output of the air-fuel ratio detection means, and
means for controlling air-fuel ratio fluctuation, which operates before the feedback control means is operated after the startup of the internal combustion engine and forcibly fluctuates an air-fuel ratio of emissions flowing to the catalyst between a lean air-fuel ratio and a rich air-fuel ratio, wherein:
the means for controlling air-fuel ratio fluctuation operates on the basis of a cycle and an amplitude that are so determined that both O₂ and CO concentrations in emissions at an inlet of the catalyst are higher than during operation of the feedback control means.

2. The exhaust emission control device of an internal combustion engine according to claim 1, wherein:
the amplitude of fluctuation caused by the means for controlling air-fuel ratio fluctuation is set greater than an amplitude during the operation of the feedback control means.

3. The exhaust emission control device of an internal combustion engine according to claim 2, wherein:
the cycle of fluctuation caused by the means for controlling air-fuel ratio fluctuation is set shorter in a rich air-fuel ratio side than in a lean air-fuel ratio side.

4. The exhaust emission control device of an internal combustion engine according to claim 2, wherein:
the amplitude of fluctuation caused by the means for controlling air-fuel ratio fluctuation is set greater in the rich air-fuel ratio side than in the lean air-fuel ratio side.

5. The exhaust emission control device of an internal combustion engine according to claim 4, wherein:
the cycle of fluctuation caused by the means for controlling air-fuel ratio fluctuation is set shorter in the rich air-fuel ratio side than in the lean air-fuel ratio side.
